(19) United States
(12) Patent Application Publication
(10) Pub. No.: US 2016/0257226 A1
(43) Pub. Date: Sep. 8, 2016

(54) METHODS AND APPARATUS FOR A VEHICLE-RIDER ARM REST

(71) Applicant: Robert Michael Quinlan, Roseville, CA (US)

(72) Inventor: Robert Michael Quinlan, Roseville, CA (US)

(73) Assignee: Driver's Elbow Pad, Corp, Roseville, CA (US)

(21) Appl. No.: 14/641,183

(22) Filed: Mar. 6, 2015

(51) Int. Cl. B60N 2/46; B62D 65/14; B60J 5/04

(52) U.S. Cl. CPC B60N 2/4673; B60J 5/0493; B62D 65/14

(57) ABSTRACT

The present invention comprises a vehicle-rider arm rest, comprising a brace having a first section configured to be inserted at least partially within an interior portion of a vehicle door and a second section extending from the first section and configured to be supported only by a an upper portion of a vehicle door; and a pad configured to be detachably coupled directly to the second section.

### TECHNICAL FIELD OF THE INVENTION

Embodiments of the invention are related to apparatuses, systems, structures, and methods supporting a vehicle rider's arm.

### BACKGROUND OF THE INVENTION

Drivers often spend long periods of time their automobiles. Semi-truck, freight hauling, service delivery persons, and others spend a significant amount of time their vehicles. Drivers and other riders may develop fatigued or weary limbs, such as elbows and arms, while driving.

### BRIEF SUMMARY OF THE INVENTION

In some embodiments, the present invention may comprise a vehicle-rider arm rest, comprising a brace having a first section configured to be inserted at least partially within an interior portion or area of a vehicle door and a second section extending from the first section and configured to be supported only by an upper portion, such as a sill or a door sill, of a vehicle door; and a pad configured to be detachably coupled directly to the second section.

In further embodiments of the present invention, the invention may comprise a method of forming a vehicle-rider arm rest, comprising forming a removable brace comprising: forming a first section that at least partially fits within an opening of a vehicle door sized and configured to accommodate a window; and forming a second section extending at an angle from the first section, comprising: forming at least a first fastening member on the second section configured to receive a mating fastening member from a device configured to be detachably coupled to the second section forming a supportive arm pad sized and configured to support a vehicle-rider's arm attaching to the supportive arm pad at least a second fastening member sized and configured to mate with the at least a first fastening member; and attaching the at least a second fastening member to the first fastening members.

In yet further embodiments of the present invention, the invention may comprise a vehicle door, comprising: at least one vehicle-rider arm rest, comprising: a brace having a first section configured to be inserted at least partially within an interior portion of a vehicle door and a second section extending from the first section and configured to be supported by an upper portion, such as a sill, such as a door or a window sill, of a vehicle door, wherein the first section may comprise multiple rows of perforations configured to enable the first section to fracture upon the application of adequate force such as from a vehicle accident, crash or impact. The second section may comprise at least one open-ended cut-out The vehicle-rider arm rest may further comprise a pad configured to be detachably coupled directly to the second section.

### BRIEF DESCRIPTION OF DRAWINGS

While the specification concludes with claims particularly pointing out and distinctly claiming that which is regarded as the present invention, the advantages of this invention may be more readily ascertained from the following description of the invention when read in conjunction with the accompanying drawings in which:

FIG. 1A illustrates a perspective view of a vehicle-rider arm rest;

FIG. 1B illustrates a perspective view of a removable brace, a component of the vehicle-rider arm rest;

FIG. 1C illustrates a perspective view of a supportive arm pad, an additional component of the vehicle-rider arm rest;

FIG. 2 illustrates a side view of the vehicle-rider arm rest supported by a vehicle door;

FIG. 3A a side view of an additional embodiment of the vehicle-rider arm rest;

FIG. 3B a side view of an additional embodiment of the vehicle-rider arm rest;

FIG. 4A illustrates a side view of a shaped vehicle-riderarm rest;

FIG. 4B illustrates a side view of a shaped vehicle-rider arm rest;

FIG. 4C illustrates a side view of a shaped vehicle-rider arm rest;

FIG. 4D illustrates a side view of a shaped vehicle-rider arm rest;

FIG. 5 illustrates a side view of an additional embodiment of the vehicle-rider arm rest;

FIG. 6 illustrates a side view of an additional embodiment of the vehicle-rider arm rest;

FIG. 7 illustrates a side view of an additional embodiment of the vehicle-rider arm rest;

FIG. 8 illustrates an additional embodiment of the vehicle-rider arm rest; and

FIG. 9 illustrates a perspective view an additional embodiment of the vehicle-rider arm rest.

### DETAILED DESCRIPTION

The illustrations presented herein are, in some instances, not actual views of any particular vehicle door, brace, mechanism, pad or other object, but are merely idealized representations which are employed to describe the present invention. Additionally, elements common between figures may retain the same numerical designation.

Vehicles, such as semi-trucks, buses, moving vans, passenger vans, mini-vans, cars, passenger cars, and sports cars are configured to accommodate vehicle riders, such as truck drivers and truck passengers, bus drivers and bus passengers, moving van drivers and moving van passengers, van drivers and van passengers, car drivers, and car passengers. Such vehicle riders and others riding in vehicles require a solution to the problem of fatigued arms, elbows, and shoulders experienced while driving or riding in a truck or car for extended or even short periods of time. In order to improve a riders' experience, there is a need to provide a device to support vehicle riders' arms, elbows, and shoulders that is simple to install and affordable for vehicle riders.

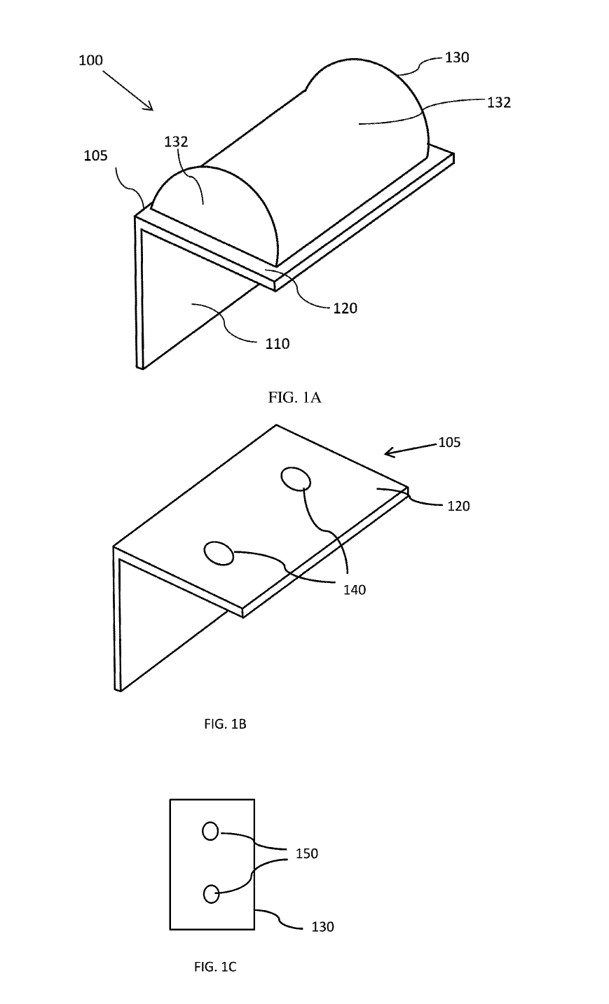

In order that the invention may be more fully understood, it will now be described, by way of example, with reference to the accompanying drawings, FIGS. 1 through 9. The term “rider” or “riders” is a generic term, meaning either a driver or a passenger, or both.

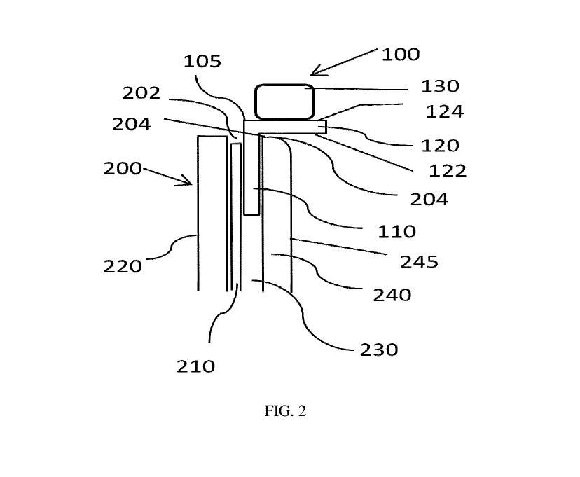

An embodiment of the invention is illustrated in FIGS. 1A, 1B, 1C, and FIG. 2. FIG. 1A shows a vehicle-rider arm rest 100, comprising a removable brace 105. The removable brace 105 may comprise a first section 110. As shown in FIG. 2, the first section 110 may be configured to be inserted at least partially within an interior slot 230 of a vehicle door 200. Referring again to FIG. 1A, a second section 120 may extend from the first section 110. The second section 120 may be configured to be supported by an upper portion of a vehicle door, such as for example, a sill 205 of a vehicle door 200. The vehicle-rider arm rest 100 may further comprise a supportive arm pad 130. The supportive arm pad 130 may be configured to be detachably coupled directly to the second section 120.

The removable brace 105 may be one, two, three, four, five, or six inches in length, or alternatively may be shorter, or longer, or may be any intermediate length, including fractions of inches between one, two, three, four, five, and six inches. In some embodiments the removable brace may have a uniform thickness. The uniform thickness may be between ⅛ inch and one inch. In other embodiments the removable brace may have a varying thickness in order to add strength in locations of high stress.

The removable brace 105 may comprise a rigid material, such as, for example, a metal, such as steel, aluminum, copper, titanium, tungsten, or other suitable metal, a plastic, such as a high-density polyethlene, polyethylene terephthalate, polyvinyl chloride, polypropylene, low-density polyethlene, a carbon composite material, fiberglass, or a recycled material, such as a recycled composite material.

Referring to FIG. 2, the vehicle-rider-arm rest 100 is configured to couple with a vehicle door, such as, for example door 200. For the purposes of this application, the door of a vehicle may be the door of a large truck, such as a semi-truck trailer, a utility truck, such as for example, a moving truck, a garbage truck or the like, a pickup truck, a van, a minivan, a sports car, or a passenger car. Referring again to FIG. 2, the vehicle door 200 may comprise an inner member 240, an outer member 220, a window 210, an interior slot 230, an opening 202, and a sill 205. The door 200 should be understood to be a generic representation of a vehicle door and does not represent any particular truck, car, or other automobile door. The inner member 240 may comprise a frame supporting other members of the door structure. The inner member 240 may comprise a metal, such as steel or aluminum, or alternatively may comprise a plastic, such as, for example, high density polyethylene or a composite material.

The outer member 220 may be coupled to the inner member 240. The outer member 220 may support other elements of the door 200. The outer member 220 may comprise a metal, such as steel or aluminum, or alternatively may comprise a plastic, such as, for example, high density polyethylene or a composite material, such as fiberglass.

In some embodiments the inner member 240 may comprise at least a vertical section 245 and a sill 205 extending therefrom at an angle in the direction of the outer member 220. The sill 205 may be integrally formed with the interior slot 230. The sill 205 may be in a plane different from the plane that the interior slot 230 is in. For example, these two planes may be perpendicular to each other, or may be a few degrees off of perpendicular to each other. The sill 205 may extend at an angle from the interior slot 230, such as a right angle or an angle larger than a right angle or an angle less than a right angle. The sill 205 may oriented approximately horizontally, such that the sill 205 would be approximately parallel with the ground when a vehicle is resting in an upright position on all tires.

The sill 205 may comprise a metal, such as steel or aluminum, or alternatively may comprise a plastic, such as, for example, high density polyethylene, or may further comprise a composite material or may comprise a cloth or carpeted material. The sill 205 may at least partially mate with the outer member 220 such that an opening 202 exists between the sill 205 and the outer member 220. In some embodiments, the sill 205 may fully mate with the outer member 220. In such embodiments, the opening 202 may be any slot in the sill 205. In further embodiments, the opening 202 may be a slot in the outer member 220. In all embodiments the opening 202 is configured to allow a window 210 to pass therethrough. The window 210 may comprise a glass material, such as tempered glass, poly(methyl methacrylate) (PMMA), or other glass well known in the art.

Referring again to FIG. 1A, a second section 120 may extend from the first section 110. The second section 120 may be configured to support the supportive arm pad 130. The second section 120 may extend from the first section 110 a distance of approximately two inches, three inches, four inches, five inches, six inches, or any distances between the aforementioned distances, or any length appropriate to support the supportive arm pad 130. The second section 120 may be integrally formed with the first section 110.

In other embodiments the first section 110 and the section 120 may be separate members of the brace 105. However, in such embodiments, the first section 110 and the second section 120 may be removably attached to each other by any appropriate fastening means.

The second section 120 may further comprise a first side 122 and a second side 124. The first side 122 may be configured to be in direct contact with the sill 205 of the door 200. The first side 122 may be configured to be in contact with and may be configured to receive support only from the sill 205 of the door 200, and to not be in contact with any other member of the door 200. The brace 105, therefore, would receive exterior support from the external portions of the door 200 from only the sill 205, and would not be in contact with any other portions thereof. Therefore, the distal end of the second section 120 may be configured to be cantilevered from a point on the sill which may be near the opening 202 in the door 200 leading to the inner portion 230 or from a point on the sill 205, leaving free standing an end of the second section 120 located distally from the opening 202. In such a configuration, the removable brace 105 and the vehicle-rider arm rest 100 receive all of the support from internal portions of the door 200 and from the sill 205.

In some embodiments, the second section 120 may extend tangentially to a point 204 on the sill 205. The point 204 may be located at any point on the sill 205. In other embodiments, the first side 122 of the second section 120 may have more than one point of contact with the sill 205. In some embodiments, a portion of the second section 120 may be in contact with a portion of the sill 205. In such an embodiment, the point 204 may be a point on the sill 205. The second section 120 may extend tangentially to the point 204. As described by these embodiments, the removable brace 105 and the vehicle-rider's arm rest 100 are supported only by the interior slots of the door 200 and the sill 205. Additionally, the supportive arm pad 130, which is configured to be coupled to the second portion 120, is configured to be positioned entirely above the sill 205. The supportive arm pad 130 is configured to be positioned entirely above the plane of the sill 205. The only portion of the vehicle arm rest that is configured to be below the level of the sill 205 is the first section 110, which rests in the interior of the door 200.

In other embodiments of the invention, the second section 120 may comprise a first shelf extending approximately parallel to the sill 205 from the first section 110. A supportive member may extend therefrom toward a floor of the vehicle, A second shelf may from the supportive member approximately parallel to the first shelf. The second shelf may be configured to support a supportive arm pad, such as the supportive arm pad 130. Such embodiments may be configured to accommodate vehicle riders, such as vehicle drivers, that may be too short to use other embodiments of the invention. As further embodiments of the invention are discussed, it should be understood that the features and attributes described herein may be incorporated into this embodiment.

In other embodiments, a second section, similar to the second section 120, and a pad, similar to the pad 130 may be partially below a plane of a sill, similar to the plane of the sill 205. In such embodiments, the second section is supported by its attachment to a first section, similar to the first section 110, and is configured to be coupled to a supportive arm pad, such as the supportive arm pad 130, however, the interior angle between the first section and the second section is an acute angle, such that the second section is directed slightly toward the floor of the automobile. Furthermore, in addition to the support received from the attachment to the first section 110, the second section 120 is configured to receive support from the sill 205. However, the second section 120 is configured to receive support only from the attachment to the first section 110 and the sill 205 and from no other members or sections of the door 200.

In some embodiments, as shown in FIG. 2, the first section 110 may be configured to be placed or inserted at least partially within an interior slot 230 of the vehicle door 200. The first section 110 may be placed fully within the interior slot 230, as shown in FIG. 2, or, in alternative embodiments, may be placed only partially within the interior slot 230 of the door 200, leaving a portion of the first section 110 outside of the interior slot 230.

In some embodiments, the first section 110 may be configured to slide freely in and out of the opening 202, having no attachment to the door 200. In further embodiments, the first section 110 may comprise a clamp, a bracket, a stud, a slidable stud, or other means to more securely fasten the vehicle-rider arm rest to the vehicle door 200.

Referring again to FIG. 1A, the supportive arm pad 130 may be configured to detachably couple directly to the second section 120. As illustrated in FIG. 1B, a removable bracket may comprise fastening members 140 on the second surface 120. As shown in FIG. 1C, the supportive arm pad 130 may comprise mating fasting members 150 on the surface configured to contact the second section 120. The fastening members 140 are configured to receive the mating fastening members 150. The supportive arm pad 130 may be configured to detachably couple to the second section 120 by a tongue and groove connection, a hook and loop connection, such as for example, Velcro®, a snap fastener, and other methods well known in the art. For example, the second side 124 of the second section 120 may be equipped with a groove fastener which may be configured to receive a mating tongue fastener mounted on a side of the supportive arm pad 130 configured to contact the second side 124 of the second section 120. In further embodiments, fastening members 140 may be located in different locations on the second section 120, such as for example the corners or sides of the second section 120, with the mating fastening members located in corresponding positions on the supportive arm pad 130. In some embodiments, the fastening members 140 may be clamps that clamp a portion of the supportive arm pad 130, holding it to the second section 120.

The supportive arm pad 130 may comprise an outer shell 132, and an inner filling material represented by 134. The outer shell 132 may comprise any fabric that would comfortable on a vehicle-rider's skin, such as for example, cotton, polyester, spandex, microfiber, silk, satin, canvas, fleece, denim, wool, animal fur, linen, lycra, leather, knit, chiffon, organza, tulle, organic based materials, recycled materials, carbon composite material, rubber, plastics, metals, synthetic materials, crepe, corduroy, velvet, netting, nylon, mesh, taffeta, micro suede, lace, or any suitable material, or combination of the above-mentioned materials. The outer shell 132, in some embodiments may comprise a rubber bladder covered by a second, softer material. In yet further embodiments, the outer shell may comprise multiple chambers, allowing for multiple inner filling materials. In some embodiments, the outer shell 132 may further comprise a sleeve attached to shell 132. The sleeve may comprise some type of fabric and may be configured to fit over the second section 120, securing the supportive arm pad 130 to the second section 120.

The inner filling 134 may comprise air to fill an air bladder, a liquid, such as for example water, a supportive gel, feather down, cotton, synthetic down, synthetic filling, carbon-based filling, such as organic material, foam, memory foam, polyester filling, fiberfill, closed-cell extruded polystyrene foam, sheet foam, high density polyurethane, material that may be adjusted to be harder or softer depending on a user's preference, such as for example a combination of an air bladder and a foam, or other suitable filling material, or any combination of these.

In some embodiments, the supportive arm pad 130 may be a pad which is attached in a manner which is not readily removable, the pad being configured to be fixed to the second section 120 by an adhesive, such as glue or epoxy or other means well known in the art.

The supportive arm pad 130 may be configured to be removed from the removable brace 105 and replaced by a new pad. In other embodiments, the supportive arm pad may be removed, and the outer shell 132 may be removed from the inner filling 134 and washed, or the outer shell 132 may be removed and washed without removing the outer shell 132 from the inner filling 134.

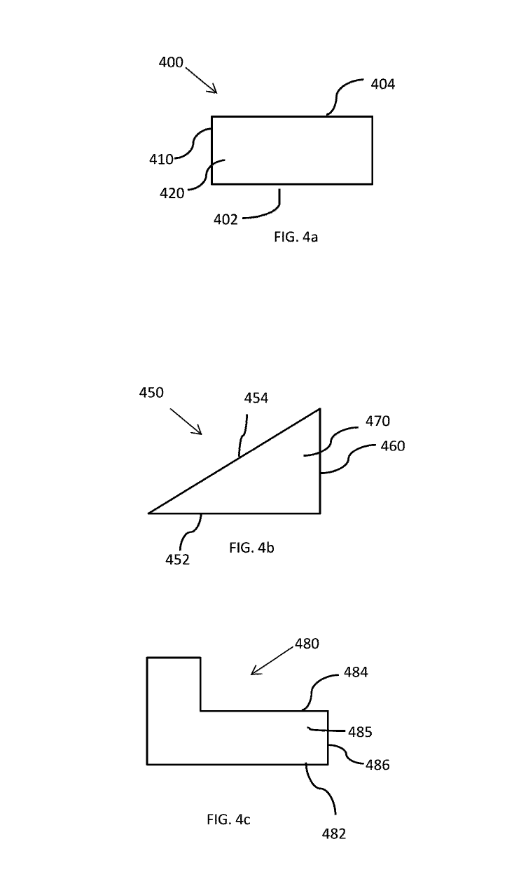

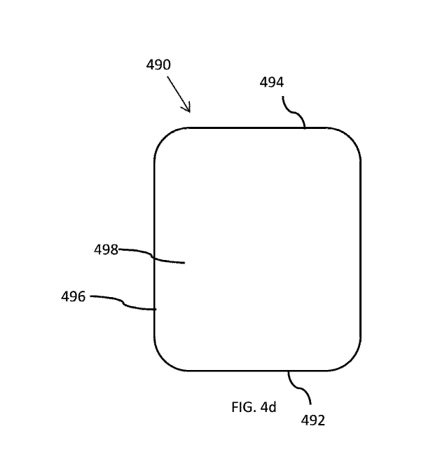

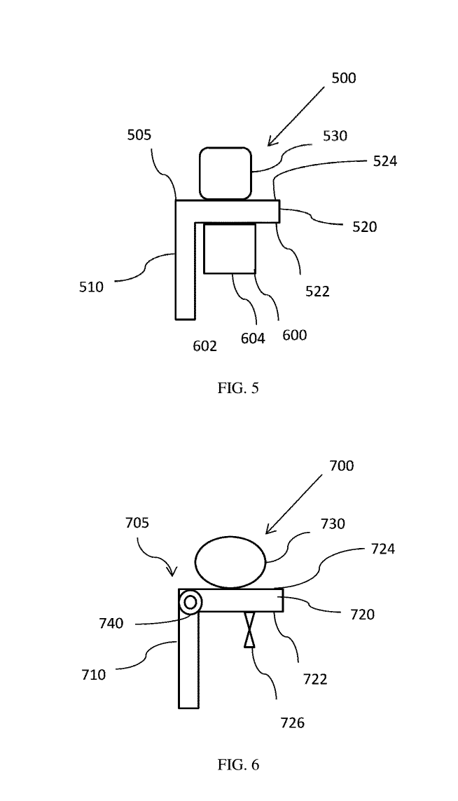

The supportive arm pad 130 may also have any suitable shape. Referring to FIG. 1A and FIG. 2, the supportive arm pad 130 may comprise a semi-circular shape. In further embodiments, as shown in the side views of FIG. 4a, the supportive arm pad 400 may comprise a rectangular shape. The supportive arm pad 400 may comprise the same elements as the supportive arm pad 130, including, for example, members configured to fasten the supportive arm pad 410 to the removable brace 105 and, an outer shell 410 and an inner filling 420.

The outer shell 410 may comprise such as, for example, any of the materials discussed previously herein.

The inner filling 420 may comprise any of the inner fillings discussed previously herein.

In further embodiments, as shown in the side views of FIG. 4b, the supportive arm pad 450 may comprise a slanted or triangular shape. The supportive arm pad 450 may comprise the same elements as the supportive arm pad 130, including, members configured to fasten the supportive arm pad 450 to the removable brace 105 and, for example, an outer shell 460 and an inner filling 470.

The outer shell 460 may comprise any fabric that would comfortable on a vehicle-rider's skin, such as, for example, any of the materials discussed previously herein.

The inner filling may comprise any of the inner fillings discussed previously herein.

In further embodiments, as shown in the side views of FIG. 4c, the supportive arm pad 480 may comprise multiple rectangular shapes, forming a step. The supportive arm pad 480 may comprise the same elements as the supportive arm pad 130, including, for example members configured to fasten the supportive arm pad 480 to the removable brace 105 and, for example, an outer shell 490 and an inner filling 495.

The outer shell 490 may comprise any fabric that would comfortable on a vehicle-rider's skin, such as for example, any of the materials discussed previously herein.

The inner filling 495 may comprise any of the inner fillings discussed previously herein.

Additionally, the supportive arm pad 130, the supportive arm pad 410, the supportive arm pad 450, and the supportive arm pad 480 may each have any appropriate thickness, such that the vehicle-rider's arm rests less than one inch, one inch, two inches, three inches, four inches, five inches, or six inches, more than six inches, or any distance therebetween, from the removable brace 105. Ideally, a vehicle-rider could replace a first supportive arm pad with a second supportive arm pad, having a height that differs from the first supportive arm pad, in order to provide the vehicle-rider with the most comfortable position during his or her ride. In some embodiments, any of the supportive arm pads discussed herein above may comprise a feature allowing the any of the outer covers to be opened, for example by interlocking teeth, such as, for example a zipper, or by button closure, fabric folding means, such as a cloth sleeve, or other opening-closure methods well known in the art, and allow more inner material to be added thereto. In further embodiments, any of the outer covers discussed herein above may be opened and removed from the inner material, may be washed and replaced, or may be discarded and replaced.

Other methods of adjusting the height of the device include the embodiment of the device illustrated in FIG. 5. FIG. 5 shows a vehicle-rider arm rest 500 having a removable brace 505 having a first section 510 and a second section 520 attached thereto. The second section 520 may comprise a first side 522 and a second side 524. A supportive arm pad 530 may be detachably coupled to the second side 524 of the second section 520. A block 600 may be attached to the first side 522 of the second section 520. The block 600 may comprise a first side 602 and a second side 604. The block 600 may comprise a rigid, solid material, such as for example, plastic, rubber, wood, metal, or other suitable material. In other embodiments, the block 600 may comprise a bladder filled with air.

In some embodiments, the block 600 may comprise fastening means to detachably couple to the first side 522 of the removable brace 505. The fastening means may include a tongue and groove connection, a hook and loop connection, such as for example, Velcro®, a snap fastener, a clamp, a cloth sleeve, and further methods well known in the art. For example, the first side 522 of the second section 520 may be equipped with a groove fastener which may be configured to receive a mating tongue fastener mounted on the first side 602 of the block 600 configured to contact the first side 522 of the second section 520. In some embodiments, the block 600 may comprise fasteners on the second side 604. The fasteners on the second side 604 may be configured to mate with a sill of a vehicle door or may be configured to mater with fasteners that may exist on a sill of a vehicle door. This configuration would allow the block to securely support an elevated automobile arm rest.

In further embodiments, the second side 604 of the block 600 may be configured to rest on a sill of a vehicle door, such as, for example the sill 205 of the door 200, as shown in FIG. 2 without the aid of any fasteners. In further embodiments, the first side 602 may not comprise any fasteners. In yet further embodiments. neither the first side 602 nor the second side 604 may comprise any fasteners. In such embodiments, the block 600 is held in place by the pressure of the vehicle-rider arm rest 500. These configurations provide a further method of raising the elevation of vehicle-rider arm rests in order to maximize the comfort of vehicle-riders.

Further manners of increasing rider comfort have also been contemplated. Referring now to FIG. 6, FIG. 6 illustrates a vehicle-rider arm rest 700 having a removable brace 705 having a first section 710 and a second section 720 attached thereto. The second section 720 may be attached to the first section 710 by a hinge member 740. The hinge member 740 may comprise a typical hinge or any mechanism which allows the second member 720 to rotate with respect to the first member 710.

The second section 720 may comprise a first side 722 and a second side 724. A supportive arm pad 730 may be detachably coupled to the second side 724 of the second section 720. The second section 722 may further comprise at least one biasing element 726. The at least one biasing element 726 may be attached to the second section 722 at one end. The opposite end of the biasing element 726 may be configured to contact a surface such as a sill of a vehicle door, such as for example, the sill 205 of the vehicle 200, as shown in FIG. 2. The at least one biasing element 726 may have varying levels of stiffness and may adjust the height and angle of the second section 720 with respect to the first section 710. The at least one biasing element 726 may include a degree of flexure, that is, it is designed to deflect or deform. The resilience of the at least one biasing element 726 will influence biasing element 200 to spring back to its initial form. The at least one biasing element 726 may comprise a compression spring, a torsion spring, a half elliptical torsion spring, a volute spring, and so on.

In other embodiments, the second section 720 may further comprise a support 728. Support 728 may be a rigid member configured to be attached to the second section 720 via a hinged support. In some embodiments the support 728 may raise the height and angle of the second section with respect to the first section 710. In further embodiments support 728 may be configured to be used with biasing element 726. In other embodiments, support 728 may be configured to be used without the assistance of biasing element 726.

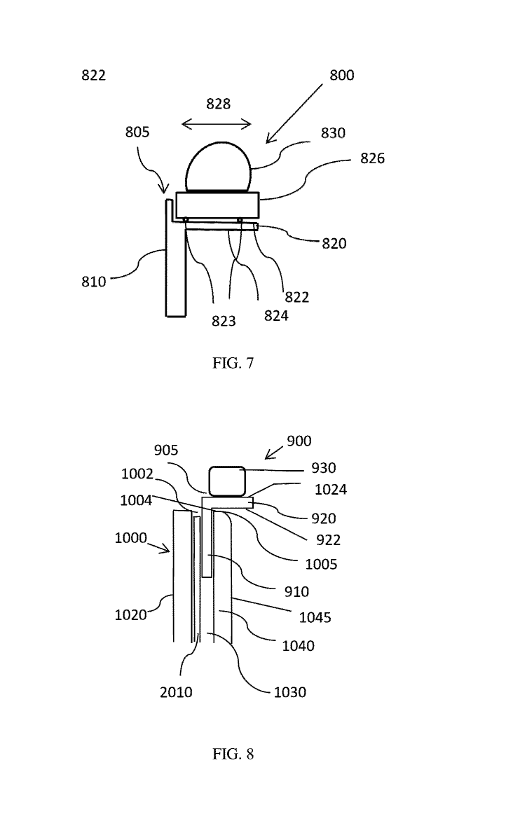

In yet further embodiments FIG. 7 illustrates a vehicle-rider arm rest 800 having a removable brace 805 having a first section 810 and a second section 820 attached thereto. The second section 820 may comprise a first side 822 and a second side 824. A supportive arm pad 830 may be detachably coupled to the second side 824 of the second section 820. The second section 822 may further comprise a frame 824. The frame 824 may comprise a slidable section or interior portion 826, configured to move or translate. The slidable section 826 may be configured to move or translate in the directions indicated by arrow 828, back and forth on the frame 824, allowing a supportive arm pad, such as any of the supportive arm pads mentioned herein, to move closer to or further away from a vehicle-rider, thereby increasing rider comfort. The frame 824 may comprise rails 823 configured to couple with sliding elements, such as, for example, wheels or rolling elements, found on the slidable section 826. The slide rails may facilitate the movement and/or translation of the slidable section 822. The slide rails may be located below the interior portion or slidable section 826 or may be located to the side of slidable section 826, such that slidable section 826 would engage the slide rails on a vertical face.

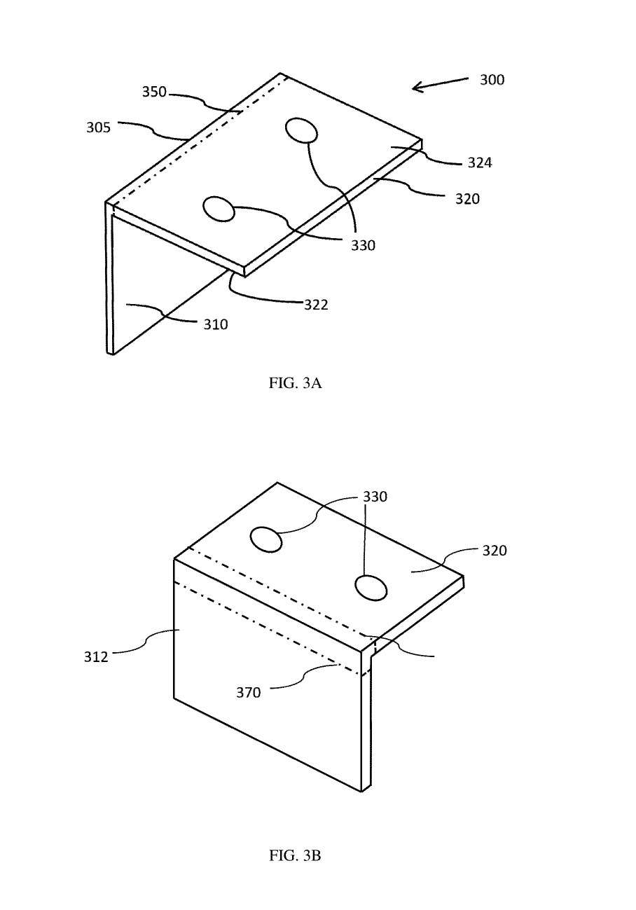

Techniques to increase vehicle rider safety have also been contemplated. Referring now to FIG. 3a, FIG. 3a illustrates a vehicle-rider arm rest 300 having a removable brace 305 having a first section 310 and a second section 320 attached thereto. The second section 320 may be attached to the first section 310. The second section 320 may further comprise a first side 322 and a second side 324. The second side 324 may comprise fasteners 330 configured to receive a supportive arm pad, such as for example the supportive arm pad 130, shown in FIG. 1A. The first side 322 may be configured to be in direct contact with a sill of a vehicle door, such as the sill 205 of the door 200. The first side 322 may be configured to be in contact with and may be configured to receive support only from a sill of a vehicle door, such as the sill 205 of the door 200, and to not be in contact with any other portion or member of the door 200. Therefore, the distal end of the second section 320 may be configured to be cantilevered from a point on the sill which may be near the opening 202 in the door 200 leading to the inner portion 230, or from a point on the sill 205, leaving free standing an end of the second section 320 located distally from the opening 202. In such a configuration, the removable brace 305 and the vehicle-rider arm rest 300 receive all of the support from internal portions of the door 200 and from the sill 205.

Additionally, the second section 320 may comprise at least one perforation 350 spanning the length of the second section 320, shown in FIG. 3a on the second side 324. The at least one perforation 350 may comprise multiple slits in the second section 320 which pass completely through the second section 320 from the first side 322 to the second side 324. This configuration may cause a weakness to develop in the second section 320. The weakness may act as a design failure point, and may be configured to fail with the application of sufficient force. Sufficient force may be applied or introduced when, for example, a rider may be resting an arm on a supportive arm pad, such as the supportive arm pad 130 and during that time, the vehicle that the vehicle rider is riding in collides with another object such as, for example, another automobile, another vehicle, a building, a tree, or a pole or post of some function. Such an impact may cause sufficient force to be applied to the second section 320 that would cause the remaining material along the at least one perforation 350 to break away, causing the second section 320 to be split into at least two pieces.

In other embodiments, the first section 310 may also comprise a perforation 370 spanning the length of the first section 310, shown in FIG. 3a on the second side 324. The at least one perforation 350 may comprise multiple openings, holes, or slits in the first section 310 which pass completely through the first section 310 from a first side to a second side of the first second. This configuration may cause a weakness to develop in the first section 310. The weakness may act as a design failure point, and may be configured to fail with the application of sufficient force. Sufficient or adequate force may be applied or introduced when, for example, a rider may be resting an arm on a supportive arm pad, such as the supportive arm pad 130 and during that time, the vehicle that the rider is riding in collides with another object such as, for example, another automobile, a building, a tree, or a pole or post of some function. Such an impact may cause sufficient force to be applied to the first section 310 that would cause the remaining material along the perforation 370 to break away, causing the first section 310 to be split into at least two pieces. In this embodiment, in the event of a collision, both the at least one perforation 350 and the perforation 370 may fracture. In the event that the at least one perforation 350 and the perforation 370 fracture the removable brace 305 will be split into at least three sections. In some instances, only the at least one perforation 350 will fracture. In other instances only the perforation 370 will fracture. In yet further instances, the at least one perforation 350 and perforation 370 may both fracture.

In yet further embodiments of the present invention, a removable brace may comprise only one perforation on the first side 310, similar to the perforation 370, configured to fracture upon the application of sufficient force. At least one of the first section 310 and the second section 320 may comprise at least one perforation configured to fracture the removable brace 105 into at least two pieces upon the application of adequate force.

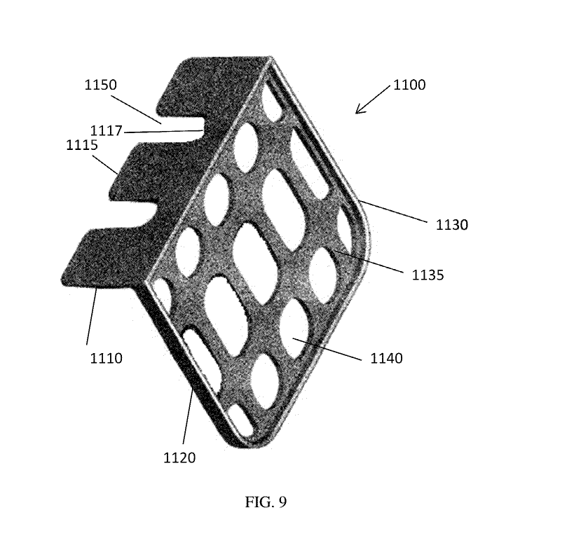

Further embodiments of the present invention comprising perforations are discussed with respect to FIG. 9, herein below.

In further embodiments, the present invention may comprise a vehicle comprising at least one vehicle door. The at least one vehicle door may comprise a vehicle-rider arm rest. The vehicle-rider arm rest may comprise elements as discussed herein in FIGS. 1 through 7, and as described in detail below with reference to FIG. 8.

For example, a vehicle may comprise an embodiment of the invention is illustrated in FIG. 8. FIG. 8 illustrates a vehicle door and a vehicle-rider arm rest 900, comprising a removable brace 905. The removable brace 905 may comprise a first section 910. The first section 910 may be configured to be inserted at least partially within an interior slot 1030 of a vehicle door 1000. A second section 920 may extend from the first section 910. The second section 920 may be configured to be supported by a sill 1005 of a vehicle door 1000. The vehicle-rider arm rest 900 may further comprise a supportive arm pad 930. The supportive arm pad 930 may be configured to be detachably coupled directly to the second section 920.

The removable brace 905 of the vehicle and vehicle door may be one, two, three, four, five, or six inches in length, or alternatively may be shorter, or longer, or may be any intermediate length, including fractions of inches between one, two, three, four, five, and six inches. In some embodiments the removable brace may have a uniform thickness. The uniform thickness may be between ⅛ inch and one inch.

The vehicle door 1000 may comprise an inner member 1040, and outer member 1020, a window 1010, an interior slot 1030, an opening 1002, and a sill 1005. The inner member 1040 may comprise a frame supporting other members of the door structure. The inner member 1040 may comprise a metal, such as steel or aluminum, or alternatively may comprise a plastic or a composite material.

The outer member 1020 may be coupled to the inner member 1040. The outer member may support other elements of the door 1000. The outer member 1020 may comprise a metal, such as steel or aluminum, or alternatively may comprise a plastic or a composite material.

The interior slot 1030 may comprise a member attached to the inner member 1040. The inner member 1040 may be located on the interior of the vehicle. The inner member 1040 may comprise a plastic or a cloth covering. In other embodiments, the inner member 1040 may comprise only a metal, such as steel or aluminum.

In some embodiments the inner slot 1030 may comprise at least a vertical section 1045 and a section extending therefrom at an angle, or a sill 1005. The sill 1005 may be integrally formed with the inner member 1040. The sill 1005 may be in a plane different from the plane that the interior slot 1030 is in. The sill 1005 may extend at an angle from the inner member 1040, such as a right angle or an angle larger than a right angle or an angle less than a right angle. The sill 1005 may oriented approximately horizontally, such that the sill 1005 would be approximately parallel with the ground when a vehicle is resting in an upright position on all tires.

The sill 1005 may comprise a metal, such as steel or aluminum, or alternatively may comprise a plastic, such as, for example, high density polyethylene or a composite material. The sill 1005 may be at least partially in contact with the outer member 1020 such that an opening 1002 exists between the sill 1005 and the outer member 1020. In some embodiments, the sill 1005 may be fully in contact with the outer member 1020. In such embodiments, the opening 1002 may be any slot in the sill 1005. In further embodiments, the opening 1002 may be a slot in the outer member 1020. In all embodiments the opening 1002 is configured to allow a window 1010 to pass therethrough. The window 1010 may comprise a glass material, such as tempered glass, polymethyl methacrylate (PMMA), or other glass well known in the art.

A second section 920 may extend from the first section 910. The second section 920 may be configured to support a supportive arm pad 930. The second section 920 may extend from the first section 910 a distance of approximately two inches, three inches, four inches, five inches, six inches, or any distances between the aforementioned distances, or any length appropriate to support the supportive arm pad 930. The second section 920 may be integrally formed with the first section 910. The second section 920 may comprise material similar to those of the first section 910.

In other embodiments of the vehicle and the vehicle door, the first section 910 and the section 920 may be separate members of the brace 905. However, the first section 910 and the second section 920 may be removably attached to each other by any appropriate fastening means.

The second section 920 may further comprise a first side 922 and a second side 924. The first side 922 may be configured to be in direct contact with the sill 1005 of the door 1000. The first side 922 may be configured to be in contact with and may be configured to receive support only from the sill 1005 of the door 1000, and to not be in contact with any other member of the door 1000. Therefore, the distal end of the second section 920 may be configured to be cantilevered from a point on the sill which may be near the opening 1002 in the door 1000 leading to the inner portion 1030 or from a point on the sill 1005, leaving free standing an end of the second section 920 located distally from the opening 1002. In such a configuration, the removable brace 905 and the vehicle-rider arm rest 900 receive all of the support from internal portions of the door 1000 and from the sill 1005.

In some embodiments of the vehicle and the vehicle door, the second section 920 may extend tangentially to a point 1004 on the sill 1005. The point 1004 may be located at any point on the sill 1005. In other embodiments, the first side 922 of the second section 920 may have more than one point of contact with the sill 1005. In some embodiments, a portion of the second section 920 may be in contact with a portion of the sill 1005. In such an embodiment, the point 1004 may be within the portion of the sill 1005. The second section 920 may extend tangentially to the point 1004. As described by these embodiments, the removable brace 905 and the vehicle-rider's arm rest 900 are supported only by the interior slots of the door 1000 and the sill 1005. Additionally, the supportive arm pad 930, which is configured to be coupled to the second portion 920, is configured to be positioned entirely above sill 1005. The supportive arm pad 930 is configured to be positioned entirely above the plane of the sill 1005. In other embodiments, the second section 920 and the pad 930 may be partially below the plane of the sill 1005. In such embodiments, the second section 920 is supported by its attachment to the first section 910, and is configured to be coupled to the supportive arm pad 930. Furthermore, in addition to the support received from the attachment to the first section 910, the second section 920 is configured to receive support from the sill 1005. However, the second section 920 is configured to receive support only from the attachment to the first section 910 and the sill 1005 and from no other members or sections of the door 1000.

Furthermore, in some embodiments, when the first section 910 is inserted into the opening 1002 and is contained at least partially within the interior slot 1030, the second section 920 does not break the plane of the lower-most level of the sill 1005, such that the second section 920 is above the sill 1005. The only portion of the vehicle-rider arm rest that is configured to be below the level of the sill 1005 is the first section 910, which rests in the interior of the door 1000.

In some embodiments, the first section 910 may be configured to be placed or inserted at least partially within an interior slot 1030 of the vehicle door 1000. The first section 910 may be placed fully within the interior slot 1030, as shown in FIG. 8, may be placed only partially within the interior slot 1030 of the door 1000, leaving a portion of the first section 910 outside of the interior slot 1030.

In some embodiments, the first section 910 may be configured to slide freely in and out of the opening 1002, having no attachment to the door 1000. In further embodiments, the first section 910 may comprise a clamp, a bracket, a stud, a slidable stud, or other means to more securely fasten the vehicle-rider arm rest to the vehicle door 1000.

The supportive arm pad 930 may be configured to detachably couple directly to the second section 920. The supportive arm pad 930 may be configured to detachably couple to the second section 920 by a tongue and groove connection, a hook and loop connection, such as for example, Velcro®, a snap fastener, a cloth sleeve, and other methods well known in the art. For example, the second side 924 of the second section 920 may be equipped with a groove fastener which may be configured to receive a mating tongue fastener mounted on a side of the supportive arm pad 930 configured to contact the second side 924 of the second section 920.

The supportive arm pad 930 may comprise an outer shell 132, and an inner filling material 134. The outer shell 132 may comprise any fabric that would comfortable on a vehicle-rider's skin, as described herein above. The outer shell 132, in some embodiments may comprise a rubber bladder covered by a second, softer material. In yet further embodiments, the outer shell may comprise multiple chambers, allowing for multiple inner filling materials.

The inner filling 134 may comprise air to fill an air bladder, a liquid, such as for example water, feather down, cotton, synthetic down, synthetic filling, carbon-based filling, such as a paper, foam, memory foam, polyester filling, fiberfill, closed-cell extruded polystyrene foam, sheet foam, high density polyurethane, material that may be adjusted to be harder or softer depending on a user's preference, such as for example a combination of an air bladder and a foam, or other suitable filling material, or any combination of these.

In some embodiments, the supportive arm pad 930 may be a pad which is attached in a manner which is not readily removable, the pad being configured to be fixed to the second section 920 by an adhesive, such as glue or epoxy or other means well known in the art.

Some embodiments of the vehicle door include the second section 920 of the vehicle-rider arm rest having at least one perforation, such as an opening, a hole, or a designed weakness, such as a portion of the second section 920 that may thinner or narrower than the surrounding portions. The at least one perforation may comprise a row of perforations in the second section 920. The row of perforation in the second section 920 may be configured to enable the second section 920 to fracture and to break entirely or at least partially away from the first section 910 with the application of adequate force. Adequate force may be applied upon violent impact, such as would occur by forcefully striking the second section or, for example, when the vehicle experiences an impact, such as a crash, with an external object, such as, for example, another vehicle, a building, a tree, or a pole or post of some function.

Furthermore, the first section 910 may comprise at least one perforation, such as an open-ended cutout or hole in the material. The at least one perforation, such as an opened ended cutout or hole, may comprise multiple perforations, open-ended cutouts, or holes, such as for example one, two, three, four or more. The illustrative examples of the perforated embodiment described with respect to FIG. 8 may be similar to those described with respect to the embodiment illustrated in FIG. 9.

Further embodiments of the invention include an exemplary embodiment illustrated in FIG. 9. FIG. 9 illustrates an embodiment similar in function and fit to embodiments of the present invention illustrated and described herein above. For example, FIG. 9 illustrates a vehicle-rider arm rest comprising a removable brace 1100 having a first section 1110 attached to a second section 1120. The first section 1110 may be configured to be inserted at least partially within an interior slot 230 of a vehicle door 200, shown in FIG. 2.

The embodiment illustrated in FIG. 9 further may comprise multiple additional features. The first section 1110 further may comprise at least one recessed section 1150. The at least one recessed section 1150 may be formed by removing a portion of the first section 1110. The at least one recessed section 1150 may comprise an area extending from a first edge 1115 of the first section 1110. The removed portion may extend from the first edge 1115 in the direction of the second section 1120. The at least one recessed section 1150 may extend a primary distance in the direction of the second section 1120. The at least one recessed section 1150 may extend less than half of the distance between the edge 1115 and the second section 1120. In other embodiments, the at least one recessed section 1150 may extend half of the distance between the edge 1115 and the second section 1120. In yet further embodiments, the at least one recessed section 1150 may extend more than half of the distance between the edge 1115 and the second section 1120. The at least one recessed section 1150 may further comprise a curved ending 1117, as shown in FIG. 9. In further embodiments, the at least one recessed section 1150 may comprise a straight or square ending, a triangular ending, or any other ending shape. As illustrated in FIG. 9, the at least one recessed section 1150 may comprise at least two recessed sections. In yet further embodiments, the at least one recessed section 1150 may comprise at least three, four, five, or more recessed sections.

In yet further embodiments of the present invention, the first section 1110 may comprise a recessed section having no free edge, contained entirely within the first section 1110. In such embodiments, the recessed section may comprise multiple recessed sections, such as, for example one, two, three, four, five, or any number of recessed sections.

In additional embodiments of the present invention, the at least one recessed section 1150 may comprise a section only partially removed such that material is removed from only one side of the first section 1110 and the at least one recessed section does not pass through the thickness of the first section 1110.

The embodiment illustrated in FIG. 9 further may comprise the second section 1120, attached to the first section 1110. The second section 1120 may be configured to extend substantially perpendicularly from the first section 1110. The second section 1120 may comprise at least one lip 1130 and at least one platform 1135. The at least one lip 1130 may extend about the perimeter of the second section 1120 and contacting the first section 1110 on opposite sides. The lip 1130 may be configured to at least partially support a supportive arm pad, such as the supportive arm pads illustrated and discussed herein.

The at least one platform 1135 may be positioned slightly depressed from the lip 1130. The at least one platform 1135 may further comprise at least one opening 1140. The at least one opening 1140 may pass completely through the at least one platform 1135. The at least one opening 1140 may be considered to be perforations, such as the at least one perforation. The at least one opening 1140 may further comprise multiple openings in the platform 1135. The at least one opening 1140 may comprise multiple shapes, such as, for example, a circle, an ellipsis, half of a circle, half of an ellipsis, a rhombus, a rectangle, a triangle an any other appropriate shape, The least one opening 1140 may act as a perforation or designed weakness, designed to fail upon impact and prevent harm to a user.

In further embodiments, the at least one opening 1140 or at least one perforation, may further comprise at least one row of openings or perforations on at least one of the first section 1110 and the second section 1120. The at least one row of openings or perforations may further comprise multiple rows of openings or perforations on at least one of the first section 1110 and the second section 1120.

The at least one opening 1140 or perforation may further comprise multiple perforations arranged in at least one pattern on at least one of the first section 1110 and the second section 1120. The pattern may comprise a pattern such as the pattern shown in FIG. 9. The pattern may comprise multiple rows or columns, or may be an pattern of offset openings 1140. In further embodiments, the openings may be randomly placed on at least one of the first section 1110 and the second section 1120.

The brace may further comprise at least a first portion multiple perforations that may be arranged in at least a first pattern on the first section 1110 and at least a second portion of the multiple perforations are arranged in at least a second pattern on the second section 1120.

In further embodiments of the present invention, the first section and the second section may integrally formed. In further embodiments, the first section and the second section may be separate pieces and may be joined by mechanisms described herein.

Further embodiments of the invention may also comprise at least one opening being located in any member, shelf, extension, or other part of the vehicle-rider brace, configured to act as a perforation and cause the vehicle-rider brace to break into at least two pieces.

Further embodiments of the present invention may include a method of forming a vehicle-rider arm rest. Referring to the previously-referenced figures, the method may include forming a removable brace 105. Forming the removable brace 105 may comprise forming a first section 110 and a second section 120, the second section 120 being formed to extend at an angle from the first section 110, such as an angle of approximately ninety degrees. The method of forming the first section 110 may comprise forming the first section 110 such that it is sized and configured to at least partially fit within an opening in a vehicle door, the opening sized and configured to accommodate at least the window 210. The method of forming the second section 120 may comprise forming at least a first fastening member 140 on the second section 120 configured to receive at least one mating fastening member 150 from a device configured to be detachably coupled to the second section 120. The method may further comprise forming a supportive arm pad 130 sized and configured to support a vehicle-rider's arm. The method may further comprise attaching to the supportive arm pad 130 at least one mating fastening member 150 sized and configured to mate with the at least a first fastening member 140.

Further embodiments include forming a perforation in the first section near the second section, configured and designed to fracture the first section and the removable brace into at least two pieces upon the application of adequate force, resulting from, for example, a vehicle impact or crash.

Further embodiments include forming an additional perforation in the second section near the first section, configured and designed to fracture the second section and the removable brace into at least two pieces upon the application of adequate force, resulting from, for example, a vehicle impact or a vehicle crash.

Further embodiments include forming only a single perforation in the second section near the first section, configured and designed to fracture the second section and the removable brace into at least two pieces upon the application of adequate force, resulting from, for example, a vehicle impact or a vehicle crash.

Further embodiments include forming a perforation in an alternate location including the intersection of the first section and the second section or forming the perforation in other locations configured to break the removable brace into two approximately equally sized pieces.

The method may further comprise forming the second section such that the second section does not break the plane of the lower most portion of the sill such that the second section 120 is above a sill of the vehicle door. The vehicle-rider arm rest is configured to such that the only portion of the vehicle-rider arm rest that is configured to be below the level of the sill of the vehicle door is the first section, which rests in the interior of the vehicle door.

Further embodiments of the present invention include a method of forming a vehicle-rider's arm rest further comprising multiple holes or perforations in the first section 1110, configured to fracture in multiple pieces and prevent injury to a vehicle rider upon the application of sufficient force caused by a vehicle impact with another object. The method of forming the vehicle-rider arm rest shown in FIG. 9, including forming the first section 1110 comprising forming at least one recessed section 1150. The at least one recessed section 1150 may be formed by removing a portion of the first section 1110. Forming the at least one recessed section 1150 may comprise forming an area extending from a first edge 1115 of the first section 1110. The removed portion may extend from the first edge 1115 in the direction of the second section 1120. The at least one recessed section 1150 may extend a primary distance in the direction of the second section 1120. The at least one recessed section 1150 may extend less than half of the distance between the edge 1115 and the second section 1120. In other embodiments, the at least one recessed section 1150 may extend half of the distance between the edge 1115 and the second section 1120. In yet further embodiments, the at least one recessed section 1150 may be formed to extend more than half of the distance between the edge 1115 and the second section 1120. Forming the at least one recessed section 1150 may further comprise forming a curved ending 1117, as shown in FIG. 9. In further embodiments, forming the at least one recessed section 1150 may comprise forming a straight or square ending, a triangular ending, or any other ending shape. As illustrated in FIG. 9, the at least one recessed section 1150 may comprise at least two recessed sections. In yet further embodiments, the at least one recessed section 1150 may comprise at least three, four, five, or more recessed sections.

In yet further embodiments of the present invention, forming the first section 1110 may comprise forming a recessed section having no free edge, contained entirely within the first section 1110. In such embodiments, the recessed section may comprise multiple recessed sections, such as, for example one, two, three, four, five, or any number of recessed sections.

In additional embodiments of the present invention, forming the at least one recessed section 1150 may comprise forming a section only partially removed such that material is removed from only one side of the first section 1110 and the at least one recessed section does not pass through the thickness of the first section 1110.

Forming the embodiment illustrated in FIG. 9 further may comprise forming the second section 1120, attached to the first section 1110. The second section 1120 may be configured to extend substantially perpendicularly from the first section 1110. The second section 1120 may comprise at least one lip 1130 and at least one platform 1135. The at least one lip 1130 may extend about the perimeter of the second section 1120 and contacting the first section 1110 on opposite sides. The lip 1130 may be configured to at least partially support a supportive arm pad, such as the supportive arm pads illustrated and discussed herein.

The at least one platform 1135 may be positioned slightly depressed from the lip 1130. The at least one platform 1135 may further comprise at least one opening 1140. The at least one opening 1140 may be formed to pass completely through the at least one platform 1135. The at least one opening 1140 may be considered to be perforations, such as the at least one perforation. The at least one opening 1140 may further comprise multiple openings in the platform 1135. The at least one opening 1140 may comprise multiple shapes, such as, for example, a circle, an ellipsis, half of a circle, half of an ellipsis, a rhombus, a rectangle, a triangle an any other appropriate shape, The least one opening 1140 may act as a perforation or designed weakness, designed to fail upon impact and prevent harm to a user.

Although the foregoing description contains many specifics, these are not to be construed as limiting the scope of the present invention, but merely as providing certain embodiments. Similarly, other embodiments of the invention may be devised which do not depart from the scope of the present invention. For example, features described herein with reference to one embodiment also may be provided in others of the embodiments described herein. The scope of the invention is, therefore, indicated and limited only by the appended claims and their legal equivalents, rather than by the foregoing description. All additions, deletions, and modifications to the invention, as disclosed herein, which fall within the meaning and scope of the claims, are encompassed by the present invention.

### EMBODIMENTS

The following illustrate embodiments of the present invention:

Embodiment 1: A vehicle-rider arm rest, comprising: a brace having a first section configured to be inserted at least partially within an interior area of a vehicle door and a second section extending from the first section, the second section configured to be supported only by an upper portion of a vehicle door; and a pad configured to be detachably coupled directly to the second section.

Embodiment 2: The vehicle-rider arm rest of embodiment 1, wherein the first section is configured to fit within a slot in a vehicle door configured to allow a window to pass through.

Embodiment 3: The vehicle-rider arm rest of embodiment 2, wherein the second section comprises a first side and a second side and wherein an upper portion of a vehicle door comprises a sill, the first side configured to contact and be supported externally by a sill.

Embodiment 4: The vehicle-rider arm rest of embodiment 3, wherein the second side of the second section is configured to be attached directly to the pad by at least one of a tongue and groove connection, a hook and loop connection, a cloth sleeve, a snap fastener, and a clamp.

Embodiment 5: The vehicle-rider arm rest of embodiment 4, wherein the brace further comprises a perforation configured to fracture upon a vehicle impact, causing a the brace to split into a first portion and a second portion.

Embodiment 6: The vehicle-rider arm rest of embodiment 5, wherein the at least one perforation comprises multiple rows of perforations.

Embodiment 7: The vehicle-rider arm rest of embodiment 6, wherein the brace comprises at least one of a steel, aluminum, a polymer plastic, and a carbon-based composite material.

Embodiment 8: The vehicle-rider arm rest of embodiment 7, wherein the pad may comprise an outer covering and an inner material, the inner material comprising at least one of a down material, a synthetic material, water, and air.

Embodiment 9: The vehicle-rider arm rest of embodiment 8, wherein the pad has a thickness of between two and six inches.

Embodiment 10: The vehicle-rider arm rest of embodiment 9, wherein the pad has a cross-sectional shape comprising at least one of a semi-circle, a rectangle, a rectangle with rounded edges, a triangle, and a step shape.

Embodiment 11: The vehicle-rider arm rest of embodiment 10, wherein the first section and the second section are integrally formed.

Embodiment 12: The vehicle-rider arm rest of embodiment 10, wherein the first section is coupled to the second section, wherein a coupling between the first section and the second section comprises at least one of a hinge and a tongue and groove insert.

Embodiment 13: The vehicle-rider arm rest of embodiment 12, wherein an angle of the second section relative to the first section may be adjusted by a biasing element configured to be attached to the second section and configured to be attached to at least one of the first section and an upper portion of a vehicle door.

Embodiment 14: The vehicle-rider arm rest of embodiment 4, wherein the second section further comprises a frame having a set of slide rails coupled to the first section and an interior portion, wherein the interior portion is configured to be slidably coupled to the frame and configured to securely slide within the slide rails.

Embodiment 15: The vehicle-rider arm rest of embodiment 14, wherein the interior portion is configured to slide at least partially in a direction toward an interior of a vehicle.

Embodiment 16: The vehicle-rider arm rest of embodiment 15, wherein the brace further comprises a perforation configured to fracture upon a vehicle impact, causing a the brace to split into at least a first portion and a second portion.

Embodiment 17: The vehicle-rider arm rest of embodiment 11, further comprising a block attached to the second section, configured to increase a height of the brace relative to a sill of a vehicle door.

Embodiment 18: A method of forming a vehicle-rider arm rest, comprising: forming a removable brace comprising: forming a first section that at least partially fits within an opening of a vehicle door sized and configured to accommodate a window; and forming a second section extending at an angle from the first section, comprising: forming at least a first fastening member on the second section configured to receive a mating fastening member from a device configured to be detachably coupled to the second section forming a supportive arm pad sized and configured to support a vehicle-rider's arm attaching to the supportive arm pad at least a second fastening member sized and configured to mate with the at least a first fastening member; and attaching the at least a second fastening member to the first fastening members.

Embodiment 19: The method of embodiment 18, further comprising forming at least one perforation in the removable bracket, the perforation configured to fracture the removable brace up the application of adequate force.

Embodiment 20: A vehicle door, comprising: at least one vehicle-riderarm rest, comprising: a brace having a first section configured to be inserted at least partially within an interior portion of a vehicle door and a second section extending from the first section and configured to be supported by an upper portion of a vehicle door, wherein the second section comprises multiple rows of perforations configured to enable the second section to fracture and at least partially separate from the first section upon the application of adequate force and wherein the first section comprises at least one open-ended cutout; and a pad configured to be detachably coupled directly to the second section.

Embodiment 21: The vehicle-rider arm rest of embodiment 6, wherein the at least one perforation further comprises at least one row of perforations on at least one of the first section and the second section.

Embodiment 22: The vehicle-rider arm rest of embodiment 21, wherein the at least one row of perforations further comprises multiple rows of perforations on at least one of the first section and the second section.

Embodiment 23. The vehicle-rider arm rest of embodiment 22, wherein the at least one perforation further comprises multiple perforations arranged in at least one pattern on at least one of the first section and the second section.

Embodiment 24: The vehicle-rider arm rest of embodiment 23, wherein at least a first portion multiple perforations are arranged in at least a first pattern on the first section and wherein at least a second portion of the multiple perforations are arranged in at least a second pattern on the second section.

Embodiment 25: The vehicle-rider arm rest of embodiment 10, wherein the first section and the second section are integrally formed.

What is claimed is:

1. A vehicle-rider arm rest, comprising:
a brace having a first section configured to be inserted at least partially within an interior area of a vehicle door and a second section extending from the first section, the second section configured to be supported by an upper portion of a vehicle door; and
a pad configured to be detachably coupled directly to the second section.

2. The vehicle-rider arm rest of claim 1, wherein the first section is configured to fit within a slot in a vehicle door configured to allow a window to pass through.

3. The vehicle-rider arm rest of claim 2, wherein the second section comprises a first side and a second side and wherein an upper portion of a vehicle door comprises a sill, the first side configured to contact and be supported externally by a sill.

4. The vehicle-rider arm rest of claim 3, wherein the second side is configured to be attached directly to the pad by at least one of a tongue and groove connection, a hook and loop connection, a snap fastener, a cloth sleeve, and a clamp.

5. The vehicle-rider arm rest of claim 4, wherein the brace comprises at least one of a steel, aluminum, a polymer plastic, and a carbon-based composite material.

6. The vehicle-rider arm rest of claim 5, wherein the pad may comprise an outer covering and an inner material, the inner material comprising at least one of a down material, a synthetic material, water, and air.

7. The vehicle-rider arm rest of claim 6, wherein the pad has a thickness of between two and six inches.

8. The vehicle-rider arm rest of claim 7, wherein the pad has a cross-sectional shape comprising at least one of a rectangle, a rectangle with rounded edges, a semi-circle, a triangle, and a step shape.

9. The vehicle-rider arm rest of claim 8, wherein the brace further comprises at least one perforation configured to fracture upon a vehicle impact, causing the brace to split into at least a first portion and at least a second portion.

10. The vehicle-rider arm rest of claim 4, wherein the at least one perforation further comprises at least one row of perforations on at least one of the first section and the second section.

11. The vehicle-rider arm rest of claim 10, wherein the at least one row of perforations further comprises multiple rows of perforations on at least one of the first section and the second section.

12. The vehicle-rider arm rest of claim 11, wherein the at least one perforation further comprises multiple perforations arranged in at least one pattern on at least one of the first section and the second section.

13. The vehicle-rider arm rest of claim 12, wherein at least a first portion multiple perforations are arranged in at least a first pattern on the first section and wherein at least a second portion of the multiple perforations are arranged in at least a second pattern on the second section.

14. The vehicle-rider arm rest of claim 13, wherein the first section and the second section are integrally formed.

15. The vehicle-rider arm rest of claim 8, further comprising a block attached to the second section, configured to increase a height of the brace relative to a sill of a vehicle door.

16. A method of forming a vehicle-rider arm rest, comprising:
forming a removable brace comprising:
forming a first section that at least partially fits within an opening of a vehicle door sized and configured to accommodate a window; and
forming a second section extending at an angle from the first section, comprising:
forming at least a first fastening member on the second section configured to receive a mating fastening member from a device configured to be detachably coupled to the second section;
forming a supportive arm pad sized and configured to support a vehicle-rider's arm;
attaching to the supportive arm pad at least a second fastening member sized and configured to mate with the at least a first fastening member; and
attaching the at least a second fastening member to the first fastening members.

17. The method of claim 16, further comprising forming at least one perforation in the removable brace, the perforation configured to fracture the removable bracket up the application of adequate force.

18. A vehicle door, comprising:
a vehicle-rider arm rest, comprising:
a brace having a first section configured to be inserted at least partially within an interior portion of a vehicle door and a second section extending from the first section and configured to be supported by an upper portion of a vehicle door, wherein the second section comprises multiple rows of perforations configured to enable the second section to fracture and at least partially separate from the first section upon the application of adequate force, and where the first section comprises at least one open-ended cutout; and
a pad configured to be detachably coupled directly to the second section.
